(19) United States
(12) Patent Application Publication
(10) Pub. No.: US 2022/0113686 A1
(43) Pub. Date: Apr. 14, 2022

(54) ELECTRONIC DEVICE AND CONTROL METHOD THEREOF

(71) Applicant: SAMSUNG ELECTRONICS CO., LTD., Suwon-si (KR)

(72) Inventors: Wonkeun OH, Suwon-si (KR); Yeji HEO, Suwon-si (KR); Jinoh KIM, Suwon-si (KR); Jaemoon LIM, Suwon-si (KR); Hyunsik JUNG, Suwon-si (KR); Laura KANG, Suwon-si (KR); Seunghan GO, Suwon-si (KR)

(73) Assignee: SAMSUNG ELECTRONICS CO., LTD., Suwon-si (KR)

(21) Appl. No.: 17/496,474

(22) Filed: Oct. 7, 2021

(30) Foreign Application Priority Data
Oct. 8, 2020 (KR) 10-2020-0130266

(51) Int. Cl. G05B 13/02; G05B 13/04; G06N 3/04

(52) U.S. Cl. CPC G05B 13/027; G06N 3/0472; G06N 3/0454; G05B 13/048

(57) ABSTRACT

An electronic device and method for predicting whether a manufactured product will exhibit a potential defect by providing measurement information of a home appliance as input to a first learning network model and a second learning network model trained to predict whether the home appliance will exhibit a potential defect, applying a first weight to first prediction information output from the first learning network model and a second weight to second prediction information output from the second learning network model, identifying a probability that the home appliance will exhibit the potential defect based on weighted first prediction information of the first prediction information to which the first weight is applied and second prediction information of the second prediction information to which the second weight is applied. The first learning network model is a supervised learning network model and the second learning network model is an unsupervised learning network model.

### CROSS-REFERENCE TO RELATED APPLICATION(S)

This application is based on and claims priority under 35 U.S.C. § 119(a) of a Korean patent application number 10-2020-0130266, filed on Oct. 8, 2020, in the Korean Intellectual Property Office, the disclosure of which is incorporated by reference herein in its entirety.

### BACKGROUND

### 1. Field

The disclosure relates to an electronic device and a control method thereof, and more particularly, to an electronic device using measurement information of a home appliance, and a control method thereof.

### 2. Description of Related Art

Spurred by the development of electronic technologies, various types of electronic devices are being developed. Recently, to meet the needs of users demanding innovative functions.

For classifying defects in manufacturing and processing steps of an electronic device and providing a product having a high level of quality and functionality to consumers, manufacturers are exerting a great amount of effort to suppress defects.

In general, a product may be determined to be defective or normal depending only on the test and measurement values acquired for individual products in manufacturing and processing steps.

Accordingly, there was a problem that, even though a product was determined as a product without defect in manufacturing and processing steps, a defect may unexpectedly occur during operations by a user.

Thus, there has been a demand for a method that enables production of data regarding defects, and provision of the data to be considered in identifying defective products during processing.

### SUMMARY

Embodiments relate to addressing manufacturing defects and providing an electronic device that predicts a defect by using a plurality of learning network models, and a control method thereof.

According to an embodiment, there is provided an electronic device including a communicator, a memory storing at least one instruction, and a processor configured to execute the at least one instruction stored in the memory, wherein the processor when executing the at least one instruction is configured to provide measurement information of a home appliance as input to a first learning network model and a second learning network model trained to predict whether the home appliance will exhibit a potential defect, apply a first weight to first prediction information output from the first learning network model and a second weight to second prediction information output from the second learning network model, and identify a probability that the home appliance will exhibit the potential defect based on weighted first prediction information of the first prediction information to which the first weight is applied and weighted second prediction information of the second prediction information to which the second weight is applied, and the first learning network model is a supervised learning network model, and the second learning network model is an unsupervised learning network model.

According to an embodiment, there is provided a method of controlling an electronic device including providing measurement information of a home appliance as input to a first learning network model and a second learning network model trained to predict whether the home appliance will exhibit a potential defect, applying a first weight to first prediction information output from the first learning network model and a second weight to second prediction information output from the second learning network model, and identifying a probability that the home appliance will exhibit the potential defect based on weighted first prediction information of the first prediction information to which the first weight is applied and weighted second prediction information of the second prediction information to which the second weight is applied, and the second learning network model is an unsupervised learning network model.

According to an embodiment, there is provided non-transitory computer-readable medium storing a computer-readable instructions, which when executed by the processor of an electronic device control the electronic device to perform a method including providing measurement information of a home appliance as input to a first learning network model and a second learning network model trained to predict whether the home appliance will exhibit a potential defect, applying a first weight to first prediction information output from the first learning network model and a second weight to second prediction information output from the second learning network model, and identifying a probability that the home appliance will exhibit the potential defect based on weighted first prediction information of the first prediction information to which the first weight is applied and weighted second prediction information of the second prediction information to which the second weight is applied, and the first learning network model is a supervised learning network model, and the second learning network model is an unsupervised learning network model.

According to the various embodiments of the disclosure as described above, a potential defect can be predicted in consideration of both process defect data and defect data according to a use by a user.

Also, a prediction model is not fixed, but a prediction model can be modified in consideration of the characteristics of defect data for the respective production steps.

In addition, accuracy and reliability of prediction can be improved by using different types of learning network models.

Further, a defect in a processing step is not identified, but a product (home appliance) wherein a defect may occur is selectively identified in a use step of a user, and thus a defect rate in a process can be reduced, and a level of completion of a product can be improved.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the disclosure;

FIG. 2 is a graph illustrating integrated learning data according to an embodiment of the disclosure;

FIG. 3 is a graph illustrating weights according to an embodiment of the disclosure;

FIG. 4 is a table illustrating defect data according to an embodiment of the disclosure;

FIG. 5 is a table illustrating clustering according to an embodiment of the disclosure;

FIG. 6 is a graph illustrating a method of acquiring weights according to an embodiment of the disclosure;

FIG. 7 is a diagram illustrating weights according to an embodiment of the disclosure; and

FIG. 8 is a diagram illustrating a control method of an electronic device according to an embodiment of the disclosure.

### DETAILED DESCRIPTION

Hereinafter, the disclosure will be described in detail with reference to the accompanying drawings.

As terms used in the embodiments of the disclosure, general terms that are currently used widely are selected as far as possible, in consideration of the functions described in the disclosure. However, the terms may vary depending on the intention of those skilled in the art or emergence of new technologies. Also, in particular instances, there may be additional terms that were specifically designated by the inventors, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

In this specification, expressions such as “have,” “may have,” “include,” and “may include” should be construed as denoting that there are such characteristics (e.g., elements such as numerical values, functions, operations, and components), and the expressions are not intended to exclude the existence of additional characteristics.

Also, the expression “at least one of A and/or B” should be interpreted to mean any one of “A” or “B” or “A and B.”

In addition, the expressions “first,” “second,” and the like used in this specification may describe various elements regardless of any order and/or degree of importance. Also, such expressions are used only to distinguish one element from another element, and are not intended to limit the elements unless otherwise expressly indicated.

Further, the description herein that one element (e.g., a first element) is “(operatively or communicatively) coupled with/to” or “connected to” another element (e.g., a second element) should be interpreted to include both the configuration in which the one element is directly coupled to the another element, and the configuration in which the one element is indirectly coupled to the another element through still another intervening element (e.g., a third element).

Meanwhile, singular expressions include plural expressions, unless defined differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Also, in the disclosure, “a module” or “a part” performs at least one function or operation, and may be implemented as hardware or software, or as a combination of hardware and software. Further, a plurality of “modules” or “parts” may be integrated into at least one module and implemented as at least one processor, except “modules” or “parts” which need to be implemented as specific hardware.

In addition, in this specification, the term “user” may refer to a person who uses, utilizes, operates, or interacts with an electronic device, and may also refer to a device using an electronic device (e.g., an artificial intelligence electronic device).

Hereinafter, an embodiment of the disclosure will be described in more detail with reference to the accompanying drawings.

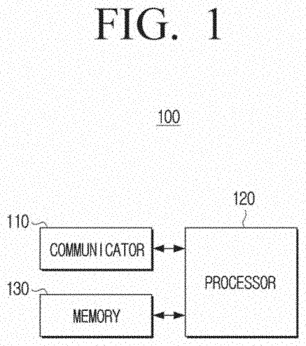

FIG. 1 is a block diagram illustrating a configuration of an electronic device according to an embodiment of the disclosure.

Referring to FIG. 1, an electronic device 100 according to an embodiment of the disclosure includes a communicator 110, a memory 120, and a processor 130.

The electronic device 100 according to an embodiment of the disclosure may include, for example, at least one of a smartphone, a tablet PC, a mobile phone, a video phone, an e-book reader, a desktop PC, a laptop PC, a netbook computer, a workstation, a server, a PDA, a portable multimedia player (PMP), an MP3 player, a medical instrument, a camera, a virtual reality (VR) implementation device, or a wearable device. Meanwhile, a wearable device may include at least one of an accessory-type device (e.g., a watch, a ring, a bracelet, an ankle bracelet, a necklace, glasses, a contact lens, or a head-mounted-device (HMD)), a device integrated with fabrics or clothing (e.g., electronic clothing), a body-attached device (e.g., a skin pad or a tattoo), or an implantable circuit. Also, in some embodiments, an electronic device may include, for example, at least one of a television, a digital video disk (DVD) player, an audio, a refrigerator, an air conditioner, a cleaner, an oven, a microwave oven, a washing machine, an air cleaner, a set top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, or an electronic photo frame.

In other embodiments, an electronic device may include at least one of various types of medical instruments (e.g., various types of portable medical measurement instruments (a blood glucose meter, a heart rate meter, a blood pressure meter, or a thermometer, etc.), magnetic resonance angiography (MRA), magnetic resonance imaging (MRI), computed tomography (CT), a photographing device, or an ultrasonic instrument, etc.), a navigation device, a global navigation satellite system (GNSS), an event data recorder (EDR), a flight data recorder (FDR), a vehicle infotainment device, an electronic device for vessels (e.g., a navigation device for vessels, a gyrocompass, etc.), avionics, a security device, a head unit for a vehicle, an industrial or a household robot, a drone, an ATM of a financial institution, a point of sales (POS) of a store, or an Internet of things (IoT) device (e.g., a light bulb, various types of sensors, a sprinkler device, a fire alarm, a thermostat, a street light, a toaster, exercise equipment, a hot water tank, a heater, a boiler, etc.).

The communicator 110 according to an embodiment of the disclosure receives data from other devices and transmits data to other devices. For example, the communicator 110 may receive inputs of various data from an external device (e.g., a source device), an external storage medium (e.g., a USB memory), an external server (e.g., a webhard), etc. through communication methods such as Wi-Fi based on AP (Wi-Fi, a wireless LAN network), Bluetooth, Zigbee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), optical, coaxial, etc.

Here, data may include measurement information of a home appliance, process defect data acquired in a processing step of a home appliance, service defect data acquired in a service step of a home appliance, etc., but the data and measurement information are not limited thereto. Explanation for measurement information of a home appliance, process defect data, and service defect data will be discussed below.

The memory 120 may store data necessary to implement the various embodiments of the disclosure. The memory 120 may be implemented in the form of a memory embedded in the electronic device 100, or implemented in the form of an external memory that can be attached to or detached from the electronic device 100 according to implementation.

For example, in the instance of data for operating the electronic device 100, the data may be stored in a memory embedded in the electronic device 100, and in the instance of data for an extension function of the electronic device 100, the data may be stored in a memory that can be attached to or detached from the electronic device 100. Meanwhile, in the instance of a memory embedded in the electronic device 100, the memory may be implemented as at least one of a volatile memory (e.g., a dynamic RAM (DRAM), a static RAM (SRAM), or a synchronous dynamic RAM (SDRAM), etc.) or a non-volatile memory (e.g., an one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash, etc.), a hard drive, or a solid state drive (SSD)). Also, in the instance of a memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), an external memory that can be connected to a USB port (e.g., a USB memory), etc.

According to an embodiment of the disclosure, the memory 120 may store a computer program including at least one instruction or instructions for controlling the electronic device 100.

According to another embodiment of the disclosure, the memory 120 may store information on an artificial intelligence model including a plurality of layers. Here, storing information on an artificial intelligence model may refer to various information related to operations of the artificial intelligence model, e.g., information on a plurality of layers included in the artificial intelligence model, information on parameters (e.g., a filter coefficient, a bias, etc.) used respectively in the plurality of layers, etc.

For example, the memory 120 may store information on first and second artificial intelligence models trained to predict whether a home appliance has a potential defect according to an embodiment of the disclosure.

Here, a potential defect means a configuration in which, in a defect test performed in a processing step (or, a manufacturing step) of a home appliance, the home appliance was identified as being within a normal range (e.g., a defect in processing did not occur), but a probability that a defect may occur in a service step of the home appliance later exceeds a threshold value. Here, a service step may mean a step after the home appliance was released and provided to a user during a normal course of appliance maintenance and service life.

The first and second learning network models according to an embodiment of the disclosure may be models trained to predict whether a defect would occur in a service step later (or, while a user uses a home appliance) even though the home appliance did not have a defect in processing, by using measurement information of the home appliance acquired in a processing step.

Here, the measurement information of the home appliance may refer to information that was acquired by testing and measuring the home appliance during a manufacturing process of the home appliance. Specifically, if the home appliance is assumed as a display panel, measurement information may include an acquired measurement value of the thickness of the thin film, an acquired chromaticity measurement value (e.g., a brightness measurement value, a spectrum measurement value, a luminance measurement value, whether there is a stain on the panel, whether there is a defective pixel), an acquired current measurement value, etc. of the display panel in a manufacturing process of the display panel. However, this is merely an embodiment, and the measurement information is not limited thereto. The various measurement information acquired by performing a test and measurement in a manufacturing, processing, or assembly process of the display panel can be included. Also, while the home appliance was assumed as a display panel for the convenience of explanation, the embodiments of the disclosure can be applied to home appliances or other appliances or devices of various forms and industries.

An artificial intelligence model may be trained. Training refers to the process by which the artificial intelligence model (e.g., an artificial intelligence model including any random parameters) is trained by using a plurality of training data by a learning algorithm, and a predefined operation rule or an artificial intelligence model set to perform a desired characteristic (or, a purpose) is thereby optimized. Such learning may be performed through a separate server and/or a system, but the training is not limited thereto, and the learning may be performed at the electronic device 100. As examples of learning algorithms, there are supervised learning, unsupervised learning, semi-supervised learning, transfer learning, or reinforcement learning, but learning algorithms are not limited to the aforementioned examples.

Here, the first and second artificial intelligence models may respectively be implemented as, for example, a convolutional neural network (CNN), a recurrent neural network (RNN), a restricted Boltzmann machine (RBM), a deep belief neural network (DBN), a bidirectional recurrent deep neural network (BRDNN), or deep Q-networks, but the artificial intelligence model is not limited thereto.

Hereinafter, for the consistency of explanation, explanation will be made by assuming the first artificial intelligence model as a supervised learning network model, and assuming the second artificial intelligence model as an unsupervised learning network model.

According to an embodiment of the disclosure, the processor 130 may be implemented as a digital signal processor (DSP), a microprocessor, a graphics processing unit (GPU), an artificial intelligence (AI) processor, a neural processing unit (NPU), and a time controller (TCON). However, the processor 130 is not limited thereto, and the processor 130 may include one or more of a central processing unit (CPU), a micro controller unit (MCU), a micro processing unit (MPU), a controller, an application processor (AP) or a communication processor (CP), and an ARM processor, or may be defined by the terms. Also, the processor 130 may be implemented as a system on chip (SoC) having a processing algorithm stored therein or large scale integration (LSI), or in the forms of an application specific integrated circuit (ASIC) and a field programmable gate array (FPGA).

Also, the processor 130 for executing an artificial intelligence model according to an embodiment of the disclosure may be implemented through a combination of a generic-purpose processor such as a CPU, an AP, a digital signal processor (DSP), etc., a graphics-dedicated processor such as a GPU and a vision processing unit (VPU), or an artificial intelligence-dedicated processor such as an NPU and software. The processor 130 may perform control to process input data according to a predefined operation rule or an artificial intelligence model stored in the memory 110. Alternatively, in case the processor 130 is a dedicated processor (or an artificial intelligence-dedicated processor), the processor 130 may be designed as a hardware structure specified for processing of a specific artificial intelligence model. For example, hardware specified for processing of a specific artificial intelligence model may be designed as a hardware chip such as an ASIC, an FPGA, etc. In the configuration the processor 130 is implemented as a dedicated processor, the processor 130 may be implemented to include a memory for implementing the embodiments of the disclosure, or implemented to include a memory processing function for using an external memory.

The processor 130 according to an embodiment of the disclosure may provide as input the measurement information of a home appliance respectively to the first and second learning network models trained to predict whether the home appliance has or will exhibit a potential defect.

Then, the processor 130 may apply different weights to first prediction information and second prediction information output from the first and second learning network models. Then, the processor 130 may identify whether the home appliance is defective, or will exhibit or is likely to exhibit a potential defect, based on the first and second prediction information to which the weights are applied.

Here, the first and second prediction information output from the first and second learning network models may respectively be in a form of probability. For example, the processor 130 may input measurement information of the home appliance into the first learning network model (e.g., a supervised learning network model), and the first learning network model may predict the probability that a defect would occur in the home appliance after release but not in a processing or manufacturing step (i.e., a potential defect) by using the measurement information, and output the first prediction information in the form of probability.

Also, the processor 130 may input measurement information of the home appliance into the second learning network model (e.g., an unsupervised learning network model), and the second learning network model may predict the probability that a defect would occur in the home appliance after release but not in a processing or manufacturing step by using the measurement information, and output the second prediction information in the form of probability.

For example, the first and second prediction information may respectively have a value of 0 to 1.

Then, the processor 130 according to an embodiment of the disclosure may identify whether the home appliance has a potential defect based on values acquired by applying different weights to the first and second prediction information respectively. For example, the processor 130 may apply weights having a value of 0 to 1 to the first and second prediction information respectively, and then sum up the weights, and if the summed up weight exceeds a threshold value, the processor 130 may determine that the home appliance has a potential defect.

Meanwhile, a supervised learning network model may be a model trained based on label data, and an unsupervised learning network model may be a model trained based on measurement information of a plurality of respective home appliances without label data.

As an example, a supervised learning network model may be a model trained to predict whether a defect may occur in the future in a home appliance corresponding to measurement information newly acquired based on a plurality of measurement information (or, learning data), in a state of clearly knowing whether the plurality of respective measurement information is measurement information of a home appliance corresponding to a defect, or measurement information of a home appliance corresponding to a normal condition.

In contrast, an unsupervised learning network model may be a model trained to predict whether a defect may occur in the future in a home appliance corresponding to measurement information newly acquired based on a plurality of measurement information, in a state of not clearly knowing whether the plurality of respective measurement information is measurement information of a home appliance corresponding to a defect, or measurement information of a home appliance corresponding to normal.

The processor 130 according to the various embodiments of the disclosure may not predict whether a home appliance has a potential defect by using only a supervised learning network model, or by using only an unsupervised learning network model, but may employ input measurement information of a home appliance both into a supervised learning network model and an unsupervised learning network model, and then predict whether the home appliance has a potential defect based on prediction information output from the respective learning network models. Accordingly, accuracy and reliability of prediction can be increased.

Meanwhile, if it is predicted that a home appliance has a potential defect based on measurement information of the home appliance, the electronic device 100 according to an embodiment of the disclosure may provide a visual or an auditory notice. For example, the electronic device 100 may provide information on which component among the various components constituting the home appliance is predicted to have a potential defect as a visual or an auditory notice. However, this is merely an example, and the electronic device 100 can simply provide only information on whether the home appliance has a potential defect as a visual or an auditory notice.

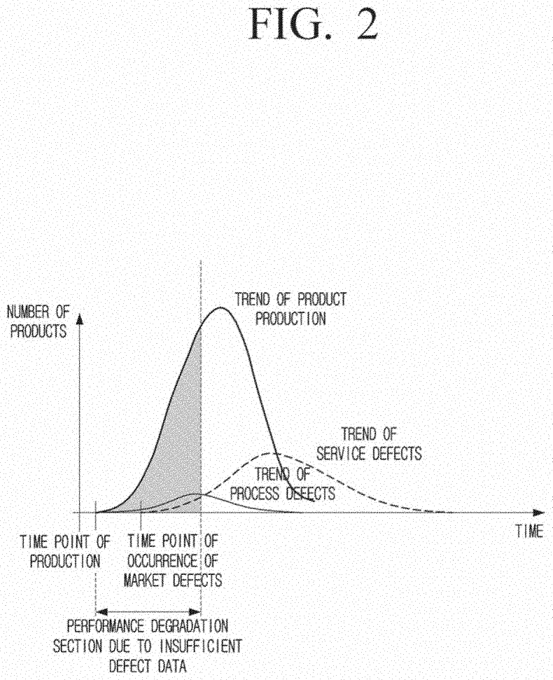

FIG. 2 is a graph illustrating integrated learning data according to an embodiment of the disclosure.

The first learning network model and the second learning network model according to an embodiment of the disclosure may be respectively trained to predict whether a home appliance has a potential defect based on integrated learning data.

Here, the integrated learning data may be data acquired by integrating process defect data acquired in a processing or manufacturing step of the home appliance and service defect data acquired in a service step of the home appliance subsequent to the manufacturing process.

According to an embodiment of the disclosure, a learning network model is trained to predict whether a defect may occur in a home appliance through use of the home appliance by a user after manufacturing, and learning data used for learning may include service defect data as well as measurement information (e.g., process defect data acquired in a processing step) of a home appliance determined as defective or normal in a manufacturing step.

Here, the service defect data may include at least one of measurement information of a home appliance determined as defective in a service step, information on a component identified as defective among a plurality of components constituting the home appliance, the service period (e.g., the use period) of the home appliance, the production date of the home appliance, or the production area (e.g., the producing factory, the production line) of the home appliance.

Depending on a period, the amount of process defect data and the amount of service defect data may be asymmetrical. For example, referring to FIG. 2, in the instance of a home appliance of which production was newly started, before the home appliance is released, the amount of service defect data acquired in a service step is close to zero (0), and only process defect data acquired in a processing step may exist.

Referring to FIG. 2, as time passes after production of a home appliance started, both of the accumulated amount of process defect data and the accumulated amount of service defect data may increase.

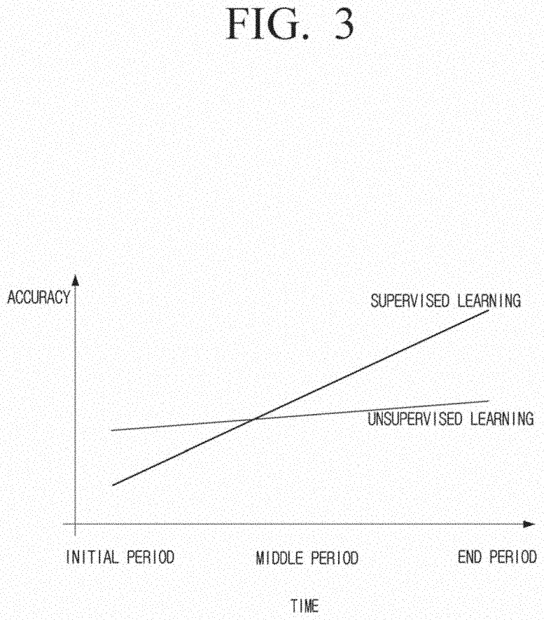

The processor 130 according to an embodiment of the disclosure may change, update, or adjust weights applied to the first and second learning network models based on the accumulated amount of integrated learning data, as described below with reference to FIG. 3.

FIG. 3 is a graph illustrating weights according to an embodiment of the disclosure.

Referring to the graph in FIG. 3, the x axis indicates passage of time, and the y axis indicates accuracy of predicting whether a home appliance will have a potential defect, i.e., prediction accuracy of a learning network model.

FIG. 3 is illustrated based on the assumption of a configuration in which, in the initial period, prediction accuracy of an unsupervised learning network model is high compared to prediction accuracy of a supervised learning network model, and in the end period, prediction accuracy of a supervised learning network model is high compared to prediction accuracy of an unsupervised learning network model.

An unsupervised learning network model performs learning based on a plurality of process data and a plurality of service data, although it may not be clearly known whether a home appliance corresponds to a defect or corresponds to normal, and thus accuracy of prediction is high in the initial period in which the accumulated amount of integrated learning data is relatively small.

In contrast, a supervised learning network model performs learning based on process data and service data, i.e., label data for which it is clearly known whether a home appliance corresponds to a defect or corresponds to normal, and thus accuracy of prediction is high in the end period in which the accumulated amount of integrated learning data is relatively large.

As illustrated in FIG. 3, the accuracy of prediction taking into account both supervised learning and unsupervised learning increases over time. However, both the initial accuracy of the models and the rate of improvement of accuracy of the models may be different. As a result, over the entire period of time from the initial period to the end period, an overall predication accuracy may be continuously achieved through the combination of models. For example, during the initial period, prediction accuracy may be improved through the unsupervised learning having a greater initial accuracy when data may be limited, despite the underperformance of the supervised learning when data is limited. On the other hand, during the end period, predication accuracy may be improved through supervised learning having a greater rate of accuracy improvement over time when data may be plentiful, despite the underperformance of the unsupervised learning when data is plentiful.

In FIG. 3, the x axis can refer to the accumulated amount of integrated learning data over time (e.g., days, months, years, etc.) that has passed after production of a home appliance has started.

If the accumulated amount of integrated learning data is smaller than a threshold value, for example when within the initial period of time, the processor 130 according to an embodiment of the disclosure may apply a weight for the unsupervised learning model that is relatively larger than a weight for a supervised learning network model. Also, if the accumulated amount of integrated learning data is greater than or equal to a threshold value, for example when within the end period of time, the processor 130 may apply a weight for the supervised learning network model that is relatively greater than a weight for an unsupervised learning network model. Accordingly, a prediction model that predicts a potential defect may flexibly change according to the accumulated amount of integrated learning data, the period of the processing step (e.g., the initial period, the middle period, the end period, etc.), the number of months that passed after production started, etc. As a result, accuracy of the prediction model may be improved across the entire product cycle.

The flexible change of a prediction model may refer to the update of an unsupervised learning network model and a supervised learning network model themselves, or the update of different weights applied to the respective prediction information output from an unsupervised learning network model and prediction information output from a supervised learning network model, as will be discussed below.

Meanwhile, a prediction model does not consist of only one learning network model, but is constituted such that a final prediction value is output by applying different weights to at least two learning network models respectively, and thus a prediction model may be referred to as an ensemble model. However, for the convenience of explanation, the prediction model will be generally referred to as a prediction model.

If process defect data and market defect data are received in real time or otherwise through the communicator 110, the processor 130 according to an embodiment of the disclosure may integrate the process defect data and the market defect data and store the data in the memory 120 as integrated learning data.

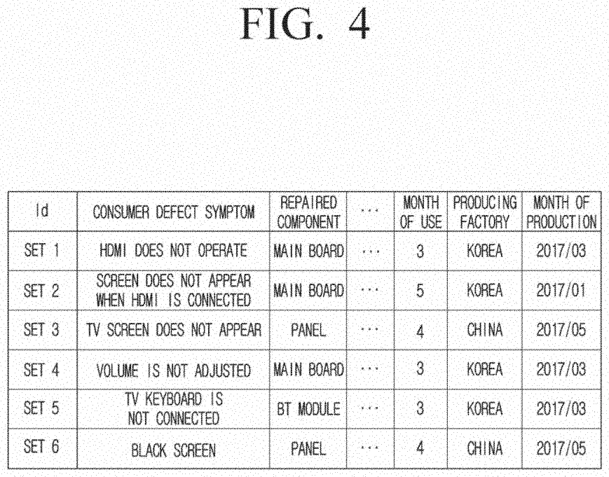

Here, the process defect data may include at least one of measurement information of a home appliance, or information on a component identified as defective in a processing step among a plurality of components constituting the home appliance. Also, the service defect data may include at least one of information on a component identified as defective among a plurality of components constituting a home appliance, the service period (e.g., time passed after release, a use time of a user, etc.), the production date of the home appliance, or the production area of the home appliance. A form of service defect data according to an embodiment of the disclosure will be explained with reference to FIG. 4.

FIG. 4 is a table illustrating defect data according to an embodiment of the disclosure.

Referring to FIG. 4, service defect data according to an embodiment of the disclosure may include information on respective different categories regarding a home appliance for which a service defect occurred. As an example, service defect data may have categories such as consumer defect symptoms, repaired components, the month of use, the producing factory, the production date, etc. Here, consumer defect symptoms and repaired components may mean information on components identified as defective, and the month of use may mean the service period.

FIG. 4 illustrates only an example of categories for the convenience of explanation, but the service defect data is not limited thereto. For example, service defect data can have identification information related to a home appliance that is maintained/managed in the A/S step of the home appliance, the manufacturer, the production area, and the production date regarding components identified as defective, the specification, the scenario (the use example) when a defect occurred, etc. as categories.

Returning to FIG. 3, the processor 130 according to an embodiment of the disclosure may update the first and second learning network models based on at least one of the accumulated amount of integrated learning data, the period of the processing step (e.g., the initial period, the middle period, the end period, etc.), or the number of months that passed after production of the home appliance started, etc. For example, if new process defect data and service defect data are received, the processor 130 may train the first and second learning network models based on the newly received process defect data and service defect data. Accordingly, the processor 130 may perform a role of triggering update of the first and second learning network models based on the amount of defect data received in real time, the period of the processing step, etc.

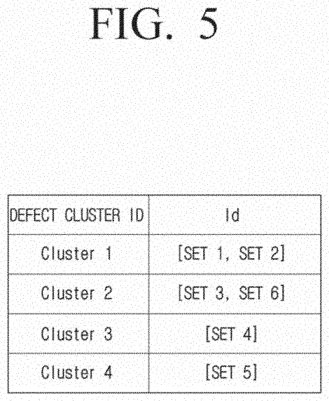

FIG. 5 is a table illustrating clustering according to an embodiment of the disclosure.

Referring to FIG. 5, the processor 130 according to an embodiment of the disclosure may perform preprocessing during a process of integrating process defect data and service defect data and acquiring integrated learning data. Here, preprocessing may mean grouping or organizing a plurality of learning data for respective categories.

As an example, the processor 130 may cluster a plurality of learning data such as process defect data and service defect data, etc. and distinguish the data as learning data groups for respective different categories. For example, the processor 130 may cluster service defect data, and distinguish the data for respective groups of clustered data, and train a prediction model. Accordingly, a prediction model performs learning based on data groups generated by clustering similar defects, and thus prediction accuracy can be improved.

Here, explaining data groups generated by clustering similar defects in detail, reasons for defects of a plurality of service defect data included in one group are the same or similar, and distribution of measurement data values in the processing step of defects for the respective clusters is similar.

Here, reasons for defects (or, keywords representing groups) may refer to main factors or variables having high relevance with defects, and the main factors can be expressed as categories and keywords.

Referring to FIG. 5, the processor 130 may group a plurality of learning data for respective repaired components, respective producing factories, and respective production dates by applying a clustering algorithm (e.g., a K-means algorithm) to the plurality of learning data.

Then, the processor 130 may train the first and second learning network models based on learning data for respective groups. As learning network models are trained by using learning data grouped for respective categories by applying a clustering algorithm, there is an effect that prediction accuracy is improved.

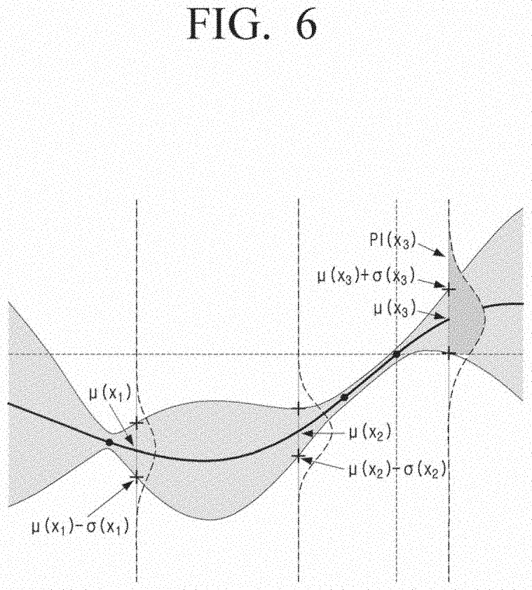

FIG. 6 is a graph illustrating a method of acquiring weights according to an embodiment of the disclosure.

Referring to FIG. 6, the processor 130 according to an embodiment of the disclosure may acquire an optimal prediction model by flexibly changing a first weight applied to first prediction information and a second weight applied to second prediction information.

First, for the convenience of explanation, a configuration in which the processor 130 predicts whether a home appliance has a potential defect by using the first to third learning network models trained to predict whether there is a potential defect will be assumed.

Here, the third learning network model may be a model different from a supervised learning network model and an unsupervised learning network model, e.g., any one of a reinforcement learning network model or a transfer learning network model. Here, a transfer learning network model may be a learning network model trained based on process defect data and service defect data of another home appliance similar to a home appliance. The another home appliance similar to a home appliance may refer to a home appliance in which a difference exists in a processing or manufacturing step, a home appliance in which a difference exists in identification information (e.g., the model name), etc.

The processor 130 according to an embodiment of the disclosure may provide as input measurement information of a home appliance into each of the first to third learning network models and acquire first to third prediction information as outputs from the first to third learning network models. Then, the processor 130 may acquire a final prediction value by applying the first to third weights respectively to the first to third prediction information.

A formula for acquiring a final prediction value can be expressed as the following Formula 1.

Yₕₐₜ=W₁f(x)±W₂g(x)+W₃h(x) [Formula 1]

In Formula 1, Yₕₐₜ means a final prediction value, f(x) means the first learning network model, g(x) means the second learning network model, h(x) means the third learning network model, and W₁, W₂, W₃ respectively mean the first to third weights.

If the final prediction value is greater than or equal to the threshold value, the processor 130 according to an embodiment of the disclosure may identify that the home appliance has a potential defect, and if the final prediction value is smaller than the threshold value, the processor 130 may identify that the home appliance is normal. For example, if the final prediction value is greater than or equal to 0.5, the processor 130 may predict that a defect may occur in the service step after the home appliance is released. Here, the specific values are merely exemplary.

Meanwhile, if the first learning network model is a supervised learning network model, an example of f(x) may be expressed as Formula 2.

$$\frac{{f}_{MinPts} ( x ) {\sum }_{o ∈ {N}_{MinPts} ( x )} \frac{{lrd}_{MinPts ( o )}}{{lrd}_{MinPts ( x )}}}{\vert {N}_{MinPts ( x )} \vert} \\ {lrd}_{MinPts} ( p ) = 1 / ( \frac{{\sum }_{o ∈ {N}_{MinPts} ( p )} reach - {dist}_{MinPts} ( p , o ) }{\vert {N}_{MinPts} ( p ) \vert} ) \qquad [ Formula 2 ]$$

Also, if the second learning network model is an unsupervised learning network model, an example of g(x) may be expressed as Formula 3.

δₖ(x)=−½ log|Σₖ|−½(x−μk)^{T}Σₖ⁻¹(x−μk)+log πk

The processor 130 according to an embodiment of the disclosure may define an objective function as in Formula 4 for acquiring the first to third weights, and acquire optimal first to third weights in a direction of maximizing the value of the objective function.

$${max}_{( {W}_{1} , {W}_{2} , {W}_{3} , {f}_{h 1} , {f}_{h 2} , {g}_{h 1} , {h}_{h 1} , … )} ObjectiveFunction = \frac{T P + A U C}{F N + ɛ} \\ \qquad [ Formula 4 ]$$

Here, TP means a True Positive, FN means a False Negative, and AUC means an Area under the ROC curve.

The values TP, FN, and AUC may be defined based on the following table.

TABLE 1

Actual Answer

| | | Positive | Negative |
|---|---|---|---|
| Prediction | Positive | True Positive | False Positive |
| Result | Negative | False Negative | True Negative |

Here, True Positive may mean the ratio of home appliances predicted to be defective (the prediction result is Positive) and identified to be actually defective (the actual answer is Positive) by a prediction model, and False Negative may mean the ratio of home appliances predicted to be normal (the prediction result is Negative) and identified to be actually defective (the actual answer is Positive) by a prediction model.

The processor 130 according to an embodiment of the disclosure may use a Bayesian Optimization algorithm for acquiring optimal first to third weights, i.e., for acquiring the first to third weights in a direction of maximizing the value of the objective function.

FIG. 6 is a graph illustrating a probability distribution function according to a Bayesian Optimization algorithm.

The processor 130 may acquire a probabilistic estimation model for an objective function based on a currently input value by using Bayesian Optimization, and iteratively perform a step of acquiring the next x₍ₜ₊₁₎ in which Expected Improvement (EI) becomes maximum according to the Formula 6 for the probabilistic estimation model, and proceed with searching the next x₍ₜ₊₁₎ which is more optimized than the currently input value.

$$E I ( x ) = E [ max ( f ( x ) - f ( {x}^{+} ) , 0 ] = \{ \begin{matrix}( μ ( x ) - f ( {x}^{+} ) - ξ ) Φ ( Z ) + σ ( x ) ϕ ( z ) & if σ ( x ) > 0 \\ 0 & if σ ( x ) = 0\end{matrix} \} \\ Z = \{ \begin{matrix}\frac{μ ( x ) - f ( {x}^{+} ) ξ}{σ ( x )} & if σ ( x ) > 0 \\ 0 & if σ ( x ) = 0\end{matrix} \} \qquad [ Formula 6 ]$$

The processor 130 according to an embodiment of the disclosure may additionally perform an explicit Exploration step for the Bayesian Optimization algorithm and proceed with searching an optimal weight, to prevent the problem of dependency on the initial period (e.g., the currently input value).

The Exploration step according to an embodiment of the disclosure can be explained as below.

1. Sampling K initial point

2. Train the Model with initial point & Calculate objective function

3. Create the Surrogate model with Calculated result ((x1, f(x1)), (x2, f(x2)), . . . , (x_k, f(x_k)))

4. Select new Point randomly

5. Train the Model with new point & Calculate objective function

6. Add the result (x, f(x)) to Trial space

7. Calculate the EI & Decide Next point (x_k+1)

8. Model train with Next point & Calculate objective function

9. Add the result (x_k+1, f(x_k+1)) to Trial space

10. Update the Surrogate Mode

11. Select value x which have maximized f(x)

Unlike a conventional Bayesian Optimization algorithm, the processor 130 according to an embodiment of the disclosure may repeatedly perform the steps 4 to 6 corresponding to the Exploration step, and also repeatedly perform the steps 7 to 10, and thereby acquire optimal first to third weights that maximize an objective function.

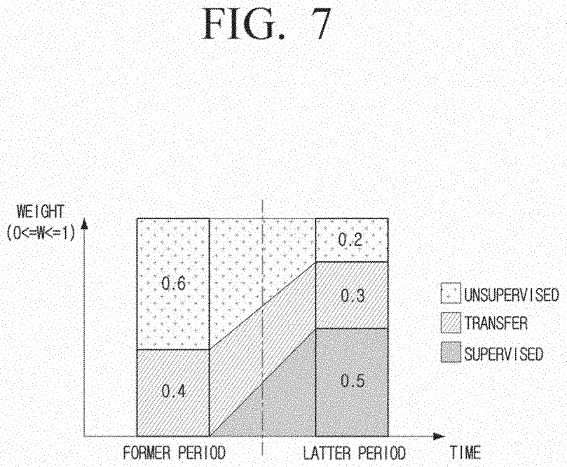

FIG. 7 is a diagram illustrating weights according to an embodiment of the disclosure.

Referring to FIG. 7, according to the time elapsed as products become manufactured and utilized by users, the processor 130 may change the first to third weights applied to the prediction information of the respective first to third learning network models.

For example, as described above, an initial stage or period has a characteristic that there is almost no service defect data, and only process defect data exists. In this scenario, the processor 130 may acquire optimal first to third weights, and apply the first to third weighs to the first to third prediction information respectively output from the first to third learning network models. For example, in an initial stage, the third weight applied to a transfer learning network model may be 0.4, and the first weight applied to an unsupervised learning network model may be 0.6.

As another example, an end stage or period has a characteristic that the accumulated amounts of service defect data and process defect data are greater than or equal to a threshold amount. In this scenario, the processor 130 may relatively decrease the third weight applied to the third prediction information output from the transfer learning network model used in prediction of a defect of another home appliance similar to a home appliance, and relatively increase the first and second weights applied to the first and second prediction information respectively output from the supervised learning network model and the unsupervised learning network model that were trained by using process defect data acquired in a processing step of a home appliance and service defect data acquired in a service step of the home appliance.

As another example, in an end stage or period, the accumulated amount of integrated learning data is greater than or equal to a threshold amount, and thus the processor 130 may relatively increase the first weight applied to the first prediction information output from the supervised learning network model that was trained based on label data that clearly informs that a home appliance has a defect. Referring to FIG. 7, in an end stage, the first weight applied to the first prediction information output from the supervised learning network model may be 0.5, the second weight applied to the second prediction information output from the unsupervised learning network model may be 0.2, and the third weight applied to the third prediction information output from the transfer learning network model may be 0.3. In the above, the weights are merely examples and are not limited to specific values.

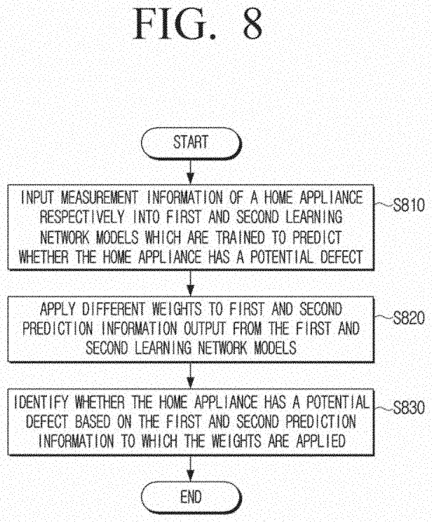

FIG. 8 is a diagram illustrating a control method of an electronic device according to an embodiment of the disclosure.

In a control method of an electronic device according to an embodiment of the disclosure, measurement information of a home appliance is input respectively into first and second learning network models trained to predict whether the home appliance has a potential defect in operation S810.

Then, weights are applied to first and second prediction information output from the first and second learning network models in operation S820.

Then, it is identified whether the home appliance has a potential defect based on the first and second prediction information to which the weights are applied in operation S830.

Here, the first learning network model may be a supervised learning network model, and the second learning network model may be an unsupervised learning network model.

The first and second learning network models according to an embodiment of the disclosure are trained to predict whether a home appliance has a potential defect based on integrated learning data, and the integrated learning data may be learning data acquired by integrating process defect data acquired in a processing step of a home appliance and service defect data acquired in a service step of the home appliance.

The control method according to an embodiment of the disclosure may further include the step of changing weights applied to the first and second learning network models based on the accumulated amount of integrated learning data.

Here, the operation S820 of applying weights may include the steps of, if the accumulated amount of integrated learning data is smaller than a threshold amount, applying a weight to the second learning network larger than a weight for the first learning network, and if the accumulated amount of integrated learning data is greater than or equal to the threshold amount, applying a weight to the first learning network larger than a weight for the second learning network.

The service defect data according to an embodiment of the disclosure may include at least one of information on a component identified as defective among a plurality of components constituting a home appliance, the service period of the home appliance, the production date of the home appliance, or the production area of the home appliance, and the process defect data may include at least one of measurement information of the home appliance or, information on a component identified as defective among a plurality of components constituting the home appliance.

Also, the measurement information of the home appliance input into the first and second learning network models may include a plurality of measurement information belonging to different categories.

The control method according to an embodiment of the disclosure may further include the steps of clustering a plurality of learning data used for training the first and second learning network models and dividing the learning data as groups of learning data for the respective different categories, and training the first and second learning network models based on the learning data for the respective groups.

Also, the control method according to an embodiment of the disclosure may further include the step of inputting measurement information of the home appliance respectively into a third learning network model trained to predict whether the home appliance has a potential defect and acquiring third prediction information. The operation S820 of applying weights may include the step of applying different weights to the first to third prediction information. The operation S830 of identifying may include the step of identifying whether the home appliance has a potential defect based on the first to third prediction information to which the different weights are applied. The third learning network model may be any one of a reinforcement learning network model or a transfer learning network model.

In addition, the control method according to an embodiment of the disclosure may further include the step of acquiring the different weights based on a Bayesian Optimization algorithm.

Meanwhile, the various embodiments of the disclosure can be applied to not only electronic devices that can perform image processing such as a display device, but all manufactured devices.

The various embodiments described above may be implemented in a recording medium that can be read and executed by a computer or a device similar to a computer, by using software, hardware, or a combination thereof. In some cases, the embodiments described in this specification may be implemented by the processor 130 itself. According to implementation by software, the embodiments such as procedures and functions described in this specification may be implemented by separate software modules. The software modules can respectively perform one or more functions and operations described in this specification.

Meanwhile, computer instructions for performing processing operations of the electronic device 100 according to the aforementioned various embodiments of the disclosure may be stored in a non-transitory computer-readable medium. Computer instructions stored in such a non-transitory computer-readable medium make the processing operations at the electronic device 100 according to the aforementioned various embodiments performed by a specific machine, when the instructions are executed by the processor of the specific machine.

A non-transitory computer-readable medium refers to a medium that stores data semi-permanently, and is readable by machines. As specific examples of a non-transitory computer-readable medium, there may be a CD, a DVD, a hard disc, a blue-ray disc, a USB, a memory card, flash memory, a ROM and the like.

While preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device comprising:
a communicator;
a memory storing at least one instruction; and
a processor configured to execute the at least one instruction stored in the memory, wherein the processor when executing the at least one instruction is configured to:
provide measurement information of a home appliance as input to a first learning network model and a second learning network model trained to predict whether the home appliance will exhibit a potential defect,
apply a first weight to first prediction information output from the first learning network model and a second weight to second prediction information output from the second learning network model, and
identify a probability that the home appliance will exhibit the potential defect based on weighted first prediction information of the first prediction information to which the first weight is applied and weighted second prediction information of the second prediction information to which the second weight is applied, wherein the first learning network model is a supervised learning network model and the second learning network model is an unsupervised learning network model.

2. The electronic device of claim 1, wherein the first learning network model and the second learning network model are trained to predict whether the home appliance has the potential defect based on integrated learning data, and
wherein the integrated learning data is data acquired by integrating process defect data acquired during a manufacturing step of the home appliance and service defect data acquired in a service step of servicing the home appliance.

3. The electronic device of claim 2, wherein the processor when executing the at least one instruction is configured to:
change the first weight applied to the first learning network model and the second weight applied to the second learning network model based on an accumulated amount of the integrated learning data.

4. The electronic device of claim 3, wherein the processor when executing the at least one instruction is configured to:
based on the accumulated amount of the integrated learning data being less than a threshold amount, increase the second weight relative to the first weight, and
based on the accumulated amount of the integrated learning data being greater than or equal to the threshold amount, increase the first weight relative to the second weight.

5. The electronic device of claim 2, wherein the service defect data comprises at least one of information on a component identified as defective among a plurality of components constituting the home appliance, a service period of the home appliance, a production date of the home appliance, or a production area of the home appliance, and
wherein the process defect data comprises at least one of measurement information of the home appliance or information on the component identified as defective among the plurality of components constituting the home appliance.

6. The electronic device of claim 1, wherein the measurement information of the home appliance includes a plurality of measurement information of different categories.

7. The electronic device of claim 6, wherein the processor when executing the at least one instruction is configured to:
cluster a plurality of learning data used for training the first learning network model and the second learning network model,
divide the plurality of learning data as groups of learning data for the respective different categories, and
train the first learning network model and the second learning network model based on the plurality of learning data for the groups of learning data.

8. The electronic device of claim 1, wherein the processor when executing the at least one instruction is configured to:
provide the measurement information of the home appliance as input to a third learning network model trained to predict whether the home appliance has the potential defect and acquire third prediction information as output,
apply a third weight to the third prediction information, and
identify whether the home appliance has the potential defect based on the weighted first prediction information, the weighted second prediction information, and weighted third prediction information of the third prediction information to which the third weight is applied, and
wherein the third learning network model is one of a reinforcement learning network model or a transfer learning network model.

9. The electronic device of claim 1, wherein the processor when executing the at least one instruction is configured to:
acquire the first weight and the second weight based on a Bayesian Optimization algorithm.

10. A method of controlling an electronic device, the method comprising:
providing measurement information of a home appliance as input to a first learning network model and a second learning network model trained to predict whether the home appliance will exhibit a potential defect;
applying a first weight to first prediction information output from the first learning network model and a second weight to second prediction information output from the second learning network model; and
identifying a probability that the home appliance will exhibit the potential defect based on weighted first prediction information of the first prediction information to which the first weight is applied and weighted second prediction information of the second prediction information to which the second weight is applied, and
wherein the first learning network model is a supervised learning network model and the second learning network model is an unsupervised learning network model.

11. The method of claim 10, wherein the first learning network model and the second learning network model are trained to predict whether the home appliance has the potential defect based on integrated learning data, and
wherein the integrated learning data is data acquired by integrating process defect data acquired during a manufacturing step of the home appliance and service defect data acquired in a service step of servicing the home appliance.

12. The method of claim 11, further comprising:
changing the first weight applied to the first learning network model and the second weight applied to the second learning network model based on an accumulated amount of the integrated learning data.

13. The method of claim 12, wherein the applying comprises:
based on the accumulated amount of the integrated learning data being less than a threshold amount, increasing the second weight relative to the first weight; and
based on the accumulated amount of the integrated learning data being greater than or equal to the threshold amount, increasing the first weight relative to the second weight.

14. The method of claim 11, wherein the service defect data comprises at least one of information on a component identified as defective among a plurality of components constituting the home appliance, a service period of the home appliance, a production date of the home appliance, or a production area of the home appliance, and
wherein the process defect data comprises at least one of measurement information of the home appliance or information on the component identified as defective among the plurality of components constituting the home appliance.

15. The method of claim 10, wherein the measurement information of the home appliance includes a plurality of measurement information of different categories.

16. The method of claim 15, further comprising:
clustering a plurality of learning data used for training the first learning network model and the second learning network model;
dividing the plurality of learning data as groups of learning data for the respective different categories; and
training the first learning network model and the second learning network model based on the plurality of learning data for the groups of learning data.

17. The method of claim 10, further comprising:
providing the measurement information of the home appliance as input a third learning network model trained to predict whether the home appliance has the potential defect and acquiring third prediction information as output;
wherein the applying comprises:
applying a third weight to the third prediction information,
wherein the identifying comprises:
identifying whether the home appliance has the potential defect based on the weighted first prediction information, the weighted second prediction information, and weighted third prediction information of the third prediction information to which the third weight is applied, and
wherein the third learning network model is one of a reinforcement learning network model or a transfer learning network model.

18. The method of claim 10, further comprising:
acquiring the first weight and the second weight based on a Bayesian Optimization algorithm.

19. A non-transitory computer-readable medium storing a computer-readable instructions, which when executed by the processor of an electronic device control the electronic device to perform a method comprising:
providing measurement information of a home appliance as input to a first learning network model and a second learning network model trained to predict whether the home appliance will exhibit a potential defect;
applying a first weight to first prediction information output from the first learning network model and a second weight to second prediction information output from the second learning network model; and
identifying a probability that the home appliance will exhibit the potential defect based on weighted first prediction information of the first prediction information to which the first weight is applied and weighted second prediction information of the second prediction information to which the second weight is applied, and
wherein the first learning network model is a supervised learning network model and the second learning network model is an unsupervised learning network model.
